(19) United States
(12) Patent Application Publication
(10) Pub. No.: US 2008/0216321 A1
(43) Pub. Date: Sep. 11, 2008

(54) SHAVING AID DELIVERY SYSTEM FOR USE WITH WET SHAVE RAZORS

(75) Inventors: Raymond Guimont, Guilford, CT (US); Meyer Rosen, East Norwich, NY (US); James Smith, Montclair, NJ (US)

Correspondence Address: MICHAUD-DUFFY GROUP LLP, 306 INDUSTRIAL PARK ROAD, SUITE 206, MIDDLETOWN, CT, 06457, US

(73) Assignee: EVEREADY BATTERY COMPANY, INC., St. Louis, MO (US)

(21) Appl. No.: 12/043,996

(22) Filed: Mar. 7, 2008

Related U.S. Application Data
(60) Provisional application No. 60/906,110, filed on Mar. 9, 2007.
(60) Provisional application No. 60/906,141, filed on Mar. 9, 2007.

(51) Int. Cl. B26B 19/38; B26B 21/52; B26B 21/00

(52) U.S. Cl. 30/41; 30/526

(57) ABSTRACT

A delivery system for a shaving aid material includes a hydrophilic foam pad or similar applicator device and shaving aid material disposed in the foam. The foam is attached to the razor cartridge such that during a shaving operation, the foam is squeezed against the user's skin and the shaving aid material is dispelled from the foam. The shaving aid material is a water soluble composition that may be impregnated into the foam, which may be a nanofoam. A razor cartridge with which the delivery system may be used has a frame that defines a skin-contacting surface, at least one razor blade located in the frame, and the shaving aid delivery system coupled to the skin-contacting surface. A shaving implement having a handle and a razor cartridge attached thereto has the shaving aid delivery system attached to the razor cartridge.

### CROSS REFERENCE TO RELATED APPLICATIONS

This application is entitled to the benefit of and incorporates by reference the disclosure of U.S. Provisional Patent Application Ser. No. 60/906,110 filed on Mar. 9, 2007. This application is related to U.S. Provisional Patent Application Ser. No. 60/906,141, filed on Mar. 9, 2007, the disclosure of which is incorporated by reference herein in its entirety.

### TECHNICAL FIELD

This invention relates generally to wet shaving systems and, more particularly, to shaving aid delivery systems that employ a hydrophilic foam as part of the delivery mechanism.

### BACKGROUND

Wet shave razor cartridges often employ what is referred to by those skilled in the shaving arts as comfort strips or glide strips. Generally, these strips are positioned on a surface of a razor cartridge that contacts a user's skin during a shaving operation. As the surface is stroked over the user's skin, the comfort or glide strips deposit shaving aid material onto the skin. The shaving aid material can be, but is not limited to, a lubricant, a medicament, or combinations thereof and as used herein the term “shaving aid” should be so construed. A problem typical of prior art comfort and glide strips is that their useful life is often shorter than the useful life of the razor blades incorporated into the razor cartridge.

Comfort strips for enhancing lubricity generally comprise matrix structures having shaving aid material in the form of lubricating polymers incorporated therein so that as the strip is moved across the skin surface, water causes the soluble portions of these polymers to leach from the matrix and be deposited onto the skin. Typically, the shaving aid becomes depleted beyond effective levels after about four or five shaves.

Both lubricating strips and comfort strips are typically manufactured using injection molding or extrusion techniques. Techniques for fabricating the comfort strips involve the molding or extrusion of the matrix material containing both the soluble polyethylene oxide blends and insoluble polymers and possibly other shaving aid materials. The matrix is generally incapable of releasing the entire soluble portion of the polymer to provide the necessary lubrication. This failure to release all of the soluble portion of the polymer is caused by insufficient exposure time of the shaving aid to water throughout the matrix structure.

Based on the foregoing, it is a general object of the present invention to provide a structure for a wet shaving system that is capable of providing a sustained, consistent release of shaving aid material from a soluble portion of a polymer to a skin surface during a shaving operation.

### SUMMARY OF THE INVENTION

In one aspect, the present invention is directed to a delivery system for a shaving aid material. The system includes a hydrophilic foam pad, strip, sponge, or similar applicator device and shaving aid material disposed in the foam. In preferred embodiments, the foam is attached to the razor cartridge such that during a shaving operation, the foam is squeezed against the user's skin and the shaving aid material is dispelled from the foam. The shaving aid material is a water soluble composition that provides any number of functions such as lubricity, moisturizing effects, skin-peels, pore cleansing, and the like. Such compositions are typically impregnated into an open-cell structure of the foam or encapsulated in closed cells of the foam. One type of foam useful in practicing the present invention is a nanofoam. As used herein, the term “nanofoam” should be broadly construed to mean foam materials having pore sizes in the nanometer range.

In another aspect, the present invention is directed to a razor cartridge having a frame that defines a skin-contacting surface, at least one razor blade having an exposed cutting edge located in the frame, and a shaving aid delivery system coupled to the skin-contacting surface and covering at least a portion thereof. The shaving aid delivery system includes a hydrophilic foam having a water soluble shaving aid material disposed therein. The shaving aid material is selectively dispensable from the hydrophilic foam in response to pressure applied to the foam resulting from contact with a user's skin during a shaving operation.

In a third aspect, the present invention is directed to a shaving implement having a handle and a razor cartridge attached thereto. A shaving aid delivery system is attached to the razor cartridge. The razor cartridge includes a frame that defines a skin-contacting surface and has at least one razor blade having an exposed cutting edge. The delivery system includes a hydrophilic foam defined by a plurality of struts or walls that define tortuous paths that form a foam strip. Shaving aid material is disposed in the tortuous paths and is dispensable from the foam when the razor cartridge (and the foam) is pressed onto a surface being shaved. The shaving aid material is a water soluble material.

One advantage of the use of hydrophilic foams as shaving aid delivery devices is that a sustained release of shaving aid can be realized. Because of the hydrophilic nature of the foam, the shaving aid material incorporated therein can be controllably solubilized and released in response to the needs of the user during a shaving operation.

Another advantage of the use of hydrophilic foams is that the durability and dimensional stability of the foam structure allows the shaving aid dispensing capability of the foam to be maintained over extended numbers of shaves. More specifically, the material from which the foam is manufactured and the particular configuration of the cell structure allows the foam to maintain its structural integrity by, for example, inhibiting the collapse of the cell structure during use. By inhibiting collapse of the cells, shaving aid material (lubricants or the like) can be more efficiently and sufficiently expelled from the foam throughout the useful life of the device into which the foam is incorporated.

### BRIEF DESCRIPTION OF THE DRAWINGS

FIG. 1 is perspective view of a lubricating strip of the present invention for a razor cartridge.

FIG. 2 is a cross-sectional representation of the lubricating strip of FIG. 1.

FIG. 3 is a side elevation view of the lubricating strip of FIG. 1 having an adhesive layer disposed thereon.

FIG. 4 is a cross-sectional representation of foam in which shaving aid material is trapped in the open-cell structure thereof.

FIG. 5 is a cross-sectional representation of foam in which shaving aid material is trapped in the closed-cell structure thereof.

FIG. 6 is a cross-sectional representation of foam in which shaving aid material is trapped between lamellae of the foam.

FIG. 7 is a perspective view of a razor cartridge incorporating the lubricating strip of the present invention.

FIG. 8 is a perspective view of a razor cartridge coupled to a handle to define a shaving device.

### DETAILED DESCRIPTION OF THE PREFERRED EMBODIMENTS

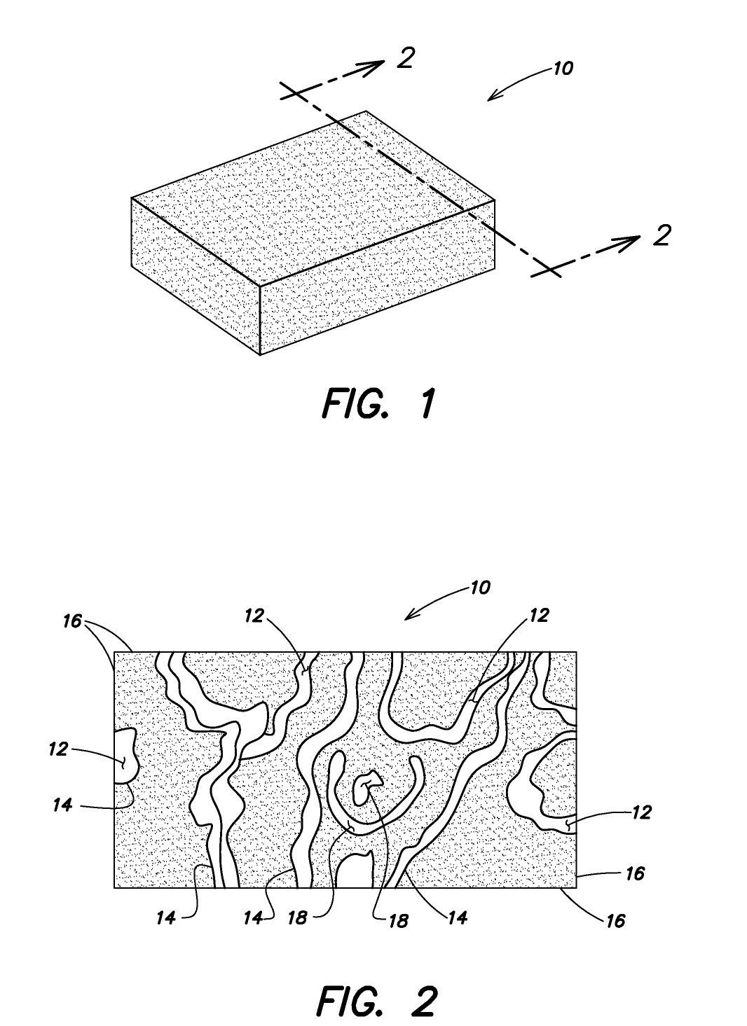

Referring to FIG. 1, a shaving aid material delivery system in the form of a lubricating (or comfort) strip for a razor cartridge is shown generally at 10 and is hereinafter referred to as “strip 10.” Strip 10 is fabricated from foam and more preferably a nanofoam having a highly reticulated open-cell structure. Strip 10 may also be a nanofoam having a closed-cell structure or a structure having a combination of open cells and closed cells. As indicated above, the term “nanofoam” should be broadly construed to mean foam materials having pore sizes in the nanometer range. As used herein, the term “open-cell” is intended to indicate a structure having a series of interconnected passageways that define a substantially open porosity. As used herein, “highly reticulated” is intended to indicate that the area defined by the cell walls is relatively small compared to the volume of the cells defined by the cell walls. In an open-cell foam structure, the open porosity allows fluid communication to be maintained through substantially all of the cells from one boundary surface of the structure to the same or any other boundary surface of the structure. The strip 10 may be located on a guard structure or surface, a cap structure or surface, or both the guard and cap surfaces of the razor cartridge. In addition, more than one comfort strip can be incorporated into a razor cartridge without departing from the broader aspects of the invention.

Referring now to FIG. 2, the strip 10 is shown as having a series of tortuous paths 12 through which fluid can be transferred. The tortuous paths 12 are defined by walls or “struts” 14 that form the cell structure. Substantially all of the tortuous paths 12 extend from one boundary surface 16 of the strip 10 to the same or another boundary surface, while some tortuous paths 12 extend into the strip from a boundary surface and terminate within the strip. Some tortuous paths 12 may originate and terminate completely within the boundary surfaces 16 to form closed cells 18.

The struts 14 impart structure to the strip 10, and the resiliency of the struts 14 give the strip its foam-like attributes. In particular, the struts 14 that form the tortuous paths 12 can be collapsed upon themselves to allow the strip 10 to be compressed. Upon compression of the strip 10 (e.g., by the application of pressure when pressing the strip onto the surface being shaved), the collapse of the struts 14 reduces the volume of void space defined by each tortuous path 12. As the volumes of the void spaces are reduced, fluid in the void spaces is forced along the tortuous paths 12 to areas of lower pressure. In general, the area of lower pressure is the area adjacent the boundary surfaces 16 outside the strip 10. In the preferred embodiments, the fluid in the void space is a shaving aid material.

The material from which the strip 10 is fabricated is preferably a hydrophilic polyurethane foam. The foam is derived from a prepolymer liquid resin prepared from low molecular weight polyols and polyoxyethylene diols with an isocyanate, particularly toluene diisocyanate. The resulting resin is an alcohol having two or more free isocyanate groups. The free isocyanate groups are hydrolyzed, thereby releasing carbon dioxide gas, which foams the resin. The hydrolysis reaction products react with unhydrolyzed isocyanate to form a second reaction product that cross links with itself and stabilizes the foam structure. Excess water molecules trapped in the struts 14 impart the hydrophilic properties to the foam.

Upon manufacture, the foam may be mounted to release paper for transport or for storage until the foam is ready to be applied to a shaving device or loaded with shaving aid material. The foam may be mounted to the release paper by dropping the foam onto the paper or by molding the foam directly to the paper. The release paper is a woven or non-woven material. The tack quality of the foam, particularly immediately after its fabrication, is generally sufficient to allow the release paper to be adhered to the foam.

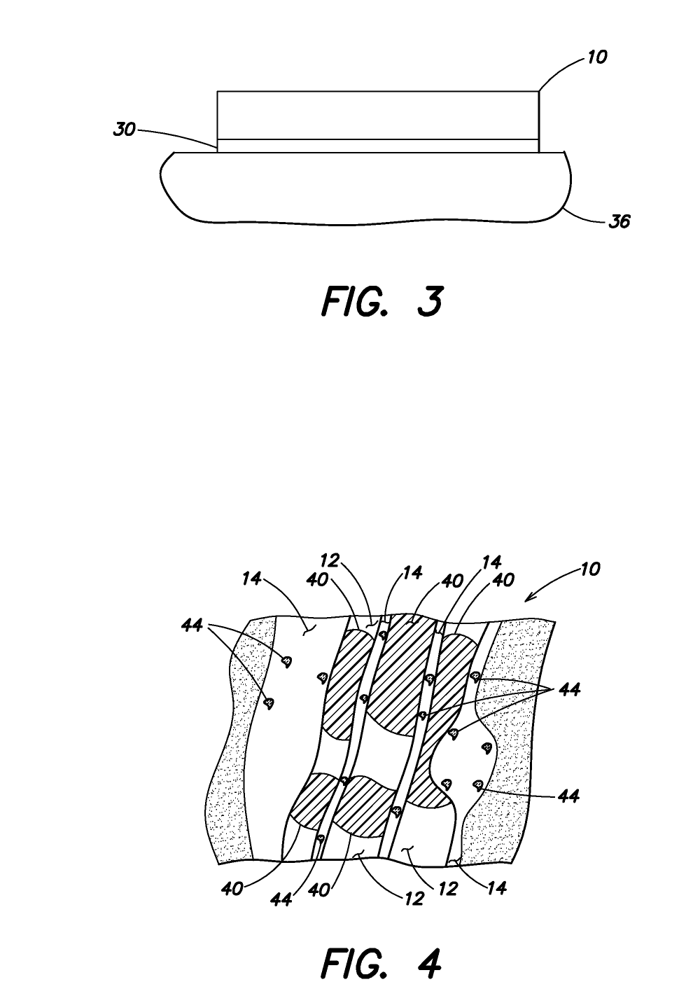

Referring now to FIG. 3, an adhesive 30 is located on a surface of the foam of the strip 10 to mount the strip to a razor cartridge for use. The adhesive 30 is preferably a layer that extends over an area of the strip 10 to facilitate the retaining of the strip on a surface 36 (e.g., the cap surface of the razor cartridge shown at 38). The adhesive 30 may be applied to the foam using any suitable technique such as rolling, spraying, or the like. The adhesive 30 may be a polyurethane or similar compound having tack characteristics and being capable of providing a bond between the foam and a surface to which the foam is to be attached.

Referring now to FIGS. 4-6, shaving aid materials that can be used with the strip 10 include, but are not limited to, lubricants, fillers, medicaments, skin-conditioners, vitamins, biocides, pharmaceuticals, humectants, surfactants, and the like. Fragrances and colorants may also be incorporated into the shaving aid materials or into the foam itself. Because of the tortuous nature of the open-cell structure of the foam, outgassing of volatile components incorporated into the foam (e.g., menthol) is minimized.

A preferred shaving aid material that may be incorporated into the strip 10 is polyethylene oxide, which can include blends of polyethylene oxide whereby polyethylene oxides having different molecular weights are mixed. Any suitable method may be used to impregnate the foam with the polyethylene oxide. During a shaving operation, water trapped in the struts 14 solubilizes the polyethylene oxide and transports it to the skin surface. Although the shaving aid material referred to hereinafter is polyethylene oxide, it should be understood that other shaving aid materials capable of reacting and performing in a similar manner can also be used with the strip 10.

The foam from which the strip 10 is formed provides a mechanism that yields a sustained release of shaving aid material over an extended number of shaves. In one embodiment, as shown in FIG. 4, polyethylene oxide is shown at 40 and is incorporated into the strip 10 by being located in the tortuous paths 12 between the struts 14. Surface tension of the polyethylene oxide 40 facilitates the retention of the material in the foam structure of the strip 10. Upon use of the strip 10 in an aqueous environment, water molecules 44 trapped in the struts 14 migrate to the water of the aqueous environment, thereby solubilizing the polyethylene oxide 40 and facilitating the transport of the polyethylene oxide to the surface being shaved. Transport of the polyethylene oxide 40 is typically effected by a user squeezing the strip 10 or otherwise applying pressure to the strip to drive the water-solubilized polyethylene oxide 40 through the tortuous paths 12 and onto the user's skin.

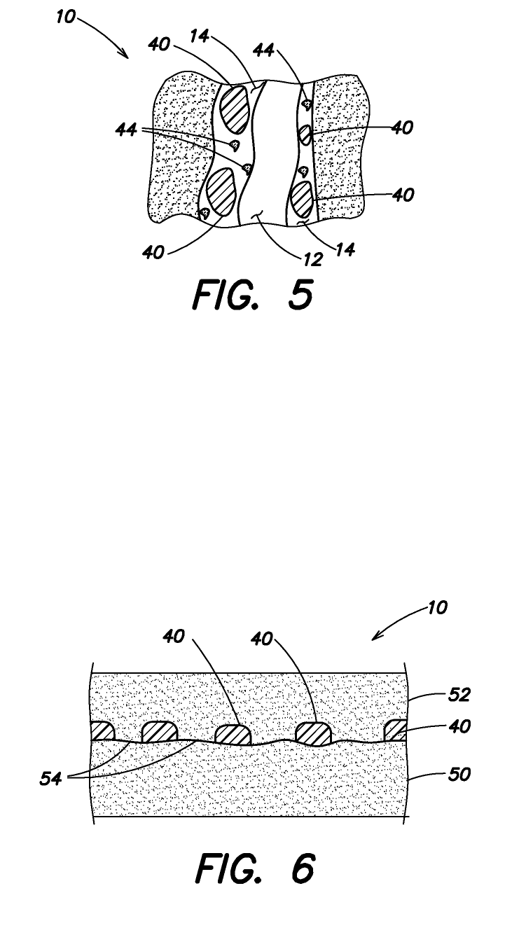

In another embodiment, as shown in FIG. 5, the polyethylene oxide 40 (or any other shaving aid material) may be encapsulated directly within the struts 14 that define the tortuous paths 12. The polyethylene oxide 40 is trapped within the void spaces within the struts 14, i.e., within closed cell portions of the foam. Upon wetting with water, the polyethylene oxide 40 leaches from the closed cells through the hydrophilic membrane of the strut 14 to the paths 12, which are in fluid communication with the aqueous environment. Once in the paths 12, the polyethylene oxide 40 can be transported in the above-described manner to the surface being shaved.

Referring now to FIG. 6, the polyethylene oxide 40 is incorporated directly into lamellae of the hydrophilic foam of the strip 10. In particular, a substrate layer 50 of foam is used to provide a base layer on which polyethylene oxide 40 is deposited in discrete quantities. A second layer 52 of foam is then deposited over the polyethylene oxide 40 and the exposed portions of the substrate layer 50. Interfaces 54 are maintained between the substrate layer 50 and the second layer 52 to promote bonding between layers of the foam and to encapsulate the polyethylene oxide 40. As above, water molecules 44 are present in the foam to facilitate the transport of the polyethylene oxide 40 through the porosity of the foam to the surface being shaved.

The mechanisms for shaving aid material transfer described with reference to FIGS. 4-6 can be used in foam individually or in combination with each other. In any embodiment, the struts 14 that define the tortuous paths 12 increase the surface area over which the shaving aid material contacts the water of the aqueous environment. By increasing the surface area over which the shaving aid material contacts the water of the aqueous environment, the water is able to permeate the foam and release the shaving aid material in a consistent manner.

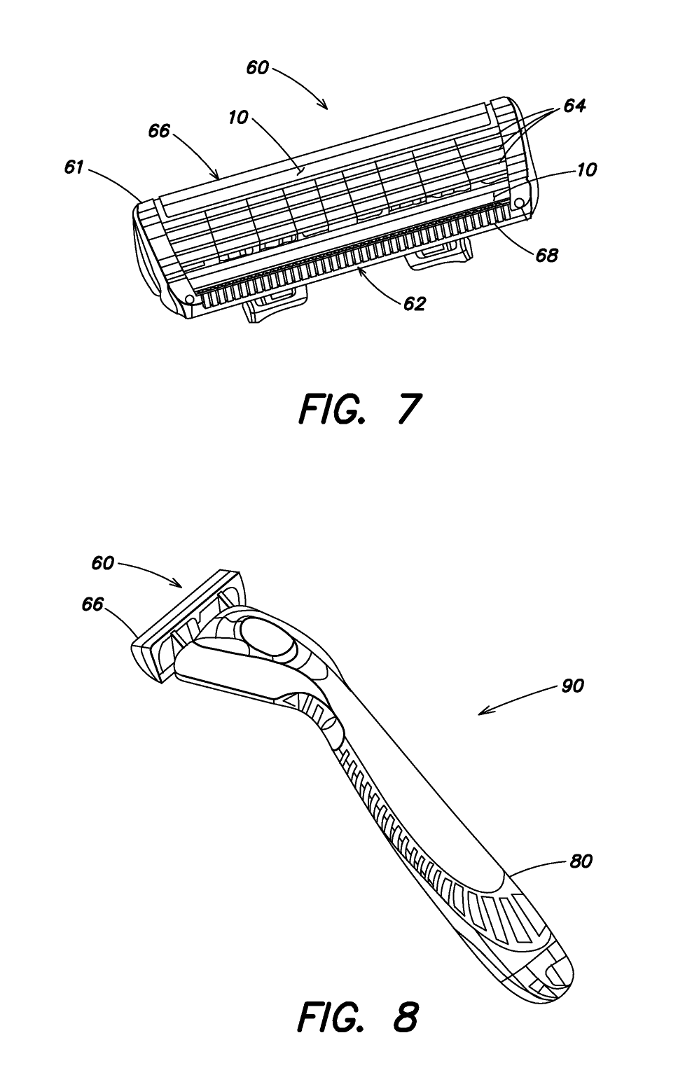

Referring now to FIG. 7, a razor cartridge incorporating the foam delivery system of the present invention is shown generally at 60. Razor cartridge 60 comprises a frame 61 that defines a skin-contacting surface. The frame 61 includes a guard portion 62, three blades 64, and a cap portion 66. The guard portion 62 is located forward of the blades 64 and in the illustrated embodiment includes a guard bar 68 for stretching a user's skin prior to the skin contacting the cutting edges defined by the blades 64. While a guard bar for stretching a user's skin has been shown and described, the present invention is not limited in this regard as a razor cartridge without a guard bar is also within the scope of the present invention. The cap portion 66 is located aft of the blades 64. A strip 10 may be located on the guard portion 62 and can be positioned aft of the guard bar 68. A strip 10 may also be located on the cap portion 66. In addition, a strip 10 can be located on both the guard portion 62 and the cap portion 66. Moreover, more than one strip can be incorporated onto one or both of the guard portion 62 and the cap portion 66.

As shown in FIG. 8, the razor cartridge 60 may be coupled to a handle 80 to define a shaving implement 90. The razor cartridge 60 can be coupled to the handle 80 in a manner such that the razor cartridge 60 is selectively detachable therefrom, or, in other instances, the razor cartridge may be permanently mounted to the handle as with disposable razors. In either case, the razor cartridge 60 may be pivotally or non-pivotally attached to the handle 80. In addition, the handle 80 may further include a biasing member that is operable to normally urge the razor cartridge 60 toward a neutral position.

Referring back to FIG. 7, in any embodiment the strips 10 incorporated into the razor cartridge 60 may be similar or identical. Preferably, at least one of the strips 10 is a nanofoam having a highly reticulated open-cell structure defined by the struts and tortuous paths and includes at least one shaving aid material (e.g., polyethylene oxide) that lubricates, medicates, or otherwise advantageously treats the surface being shaved.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A shaving aid delivery system, comprising:
a hydrophilic foam;
a shaving aid material disposed in said foam; and
wherein said shaving aid material is water soluble and selectively dispensable from said foam in response to pressure applied thereto.

2. The system of claim 1, wherein said foam is a nanofoam.

3. The system of claim 1, wherein said foam has a cell structure selected from the group consisting of open-cell structures, closed-cell structures, and combinations of open-cell structures and closed-cell structures.

4. The system of claim 1, wherein said hydrophilic foam is a polyurethane foam.

5. The system of claim 4, wherein said polyurethane foam is derived from a prepolymer liquid resin prepared from a low molecular weight polyol, a polyoxyethylene diol, and toluene diisocyanate.

6. The system of claim 1, wherein said hydrophilic foam includes entrapped water.

7. The system of claim 1, wherein said shaving aid material is selected from the group consisting of lubricants, fillers, medicaments, skin-conditioners, vitamins, biocides, pharmaceuticals, humectants, surfactants, fragrances, colorants, and combinations of the foregoing.

8. The system of claim 1, wherein said shaving aid material is polyethylene oxide.

9. The system of claim 1, wherein said shaving aid material is retained within a cell structure defined by said hydrophilic foam.

10. The system of claim 1, wherein said shaving aid material is disposed between lamellae defined by said hydrophilic foam.

11. A razor cartridge, comprising:
a frame defining a skin-contacting surface and at least one razor blade having an exposed cutting edge;
a shaving aid delivery system coupled to said skin-contacting surface and covering at least a portion thereof;
said shaving aid delivery system including a hydrophilic foam having a water soluble shaving aid material disposed therein; and wherein
said shaving aid material is selectively dispensable from said hydrophilic foam in response to pressure applied to said foam resulting from contact with a user's skin during a shaving operation.

12. A razor cartridge as defined by claim 11 wherein said hydrophilic foam is a nanofoam.

13. A razor cartridge as defined by claim 11 wherein said hydrophilic foam comprises:
a hydrolyzed reaction product of a polyol, a polyoxyethylene diol, and an isocyanate;
water trapped within said hydrolyzed reaction product; and
polyethylene oxide incorporated into said hydrolyzed reaction product.

14. A razor cartridge as defined by claim 11 wherein said shaving aid delivery system is in the form of a comfort strip coupled to said skin-engaging surface.

15. A razor cartridge as defined by claim 14 wherein:
said skin-engaging surface defines a guard portion ahead of said at least one razor blade and a cap portion aft of said at least one razor blade; and wherein
said comfort strip is coupled to at least one of said guard portion and said cap portion.

16. A razor cartridge as defined by claim 11 wherein said shaving aid delivery system is attached to said skin contacting surface and surrounds said at least one razor blade.

17. A razor cartridge as defined by claim 11 wherein said hydrophilic foam includes a plurality of struts that cooperate to define a plurality of tortuous paths and wherein said shaving aid material is disposed within said tortuous paths.

18. A razor cartridge as defined by claim 11 wherein said hydrophilic foam is defined at least in part by closed cells, at least a portion of said closed cells have a portion of said shaving aid material disposed therein, and wherein upon wetting with water said shaving aid material leaches from said closed cells through hydrophilic membranes defined by said hydrophilic foam.

19. A shaving implement, comprising:
a handle;
a razor cartridge attached to said handle, said razor cartridge comprising a frame defining a skin-contacting surface and at least one razor blade having an exposed cutting edge attached to said frame;
a shaving aid delivery system coupled to said skin-contacting surface and covering at least a portion thereof, said shaving aid delivery system comprising,
a hydrophilic foam defined by a plurality of struts that define tortuous paths,
a shaving aid material disposed in said tortuous paths, said shaving aid material being a water soluble material selectively dispensable from said foam in response to pressure applied to said foam, said pressure resulting from contact with a user's skin during a shaving operation.

20. The shaving device of claim 19, wherein said hydrophilic foam is a nanofoam.

21. The shaving device of claim 19, wherein said hydrophilic foam is a polyurethane foam derived from a prepolymer liquid resin prepared from a low molecular weight polyol, a polyoxyethylene diol, and toluene diisocyanate.

22. The shaving device of claim 19, wherein said shaving aid material is selected from the group consisting of lubricants, fillers, medicaments, skin-conditioners, vitamins, biocides, pharmaceuticals, humectants, surfactants, fragrances, colorants, and combinations of the foregoing.

23. The shaving device of claim 19, wherein said shaving aid material is polyethylene oxide.

24. The shaving device of claim 19, wherein said hydrophilic foam is a strip of foam attached to a guard surface of said razor cartridge.

25. The shaving device of claim 19, wherein said hydrophilic foam is a strip of foam attached to a cap surface of said razor cartridge.
